(19) United States
(12) Patent Application Publication
(10) Pub. No.: US 2018/0192197 A1
(43) Pub. Date: Jul. 5, 2018

(54) MULTI-FUNCTION REMOTE CONTROLLER

(71) Applicant: Wavtech, LLC, Mesa, AZ (US)

(72) Inventor: Jason Kemmerer, Thousand Oaks, CA (US)

(21) Appl. No.: 15/858,761

(22) Filed: Dec. 29, 2017

Related U.S. Application Data
(60) Provisional application No. 62/441,776, filed on Jan. 3, 2017.

(51) Int. Cl. H04R 5/04; H04S 7/00; H04B 1/08; B60R 11/02

(52) U.S. Cl. CPC H04R 5/04; H04S 7/30; B60R 2011/005; B60R 11/0264; B60R 11/0205; H04B 1/082

(57) ABSTRACT

A multifunction remote controller for an audio processor includes a function setting switch and a rotary encoder with at least one directional output terminal. At least one switch input signal corresponding to position settings of the function setting switch is generated and passed to corresponding ones of at least one switch output terminal. A rotary input signal corresponding to a specific directional input applied to the rotary encoder is generated from the at least one directional output terminal. An interconnect port in communication with the at least one switch output terminal and the at least one directional output terminal is receptive to a connector plug in communication with the audio processor.

### CROSS-REFERENCE TO RELATED APPLICATIONS

The present application claims priority to U.S. Provisional Patent Application Ser. No. 62/441,776 entitled “Multi-Function Remote Controller” filed Jan. 3, 2017, the disclosure of which is incorporated herein by reference.

### STATEMENT RE: FEDERALLY SPONSORED RESEARCH/DEVELOPMENT

Not Applicable

### BACKGROUND

### 1. Technical Field

The present disclosure relates to audio systems and input devices therefor, and more particularly, to multi-function remote controllers.

### 2. Related Art

Almost all modern automobiles are equipped with audio systems, by which various entertainment and information content may be presented to the driver and the passengers. Such audio systems are pre-installed by the automobile manufacturer, and may be referred to as stock or OEM (original equipment manufacturer) components. Typically, the stock or OEM audio system is comprised of a head unit which is the interface to the AM/FM radio, satellite radio, compact disc (CD) player, digital audio player, and navigation/GPS units. In some implementations, these modules may be integrated into the head unit.

Also connected to the head unit are loudspeakers mounted in various locations throughout the interior of the vehicle. A given speaker design has a limited frequency response that does not span the entirety of the audible frequency range, so various configurations of loudspeakers, from tweeters, mid-range speakers, full range speakers, and subwoofers are utilized. With stock/OEM systems, the enclosures for the loudspeakers are built directly into the interior vehicle panels. The radiating element of the loudspeaker may be protected with a grille that is likewise integral with the vehicle interior, and may be surrounded by dampening material to minimize excess vibration. The power output capacity of the head unit may be limited with respect to driving each of these loudspeakers, so a typical installation may also include one or more audio power amplifiers. The vehicle battery may lack sufficient peak output power to properly bias the amplifiers, so a high value capacitor may also be incorporated into the circuit.

An installer or end user may desire to control the amplification/volume levels output from the various audio amplifiers, and may incorporate a remote controller into the vehicle audio system. Conventional analog remote controllers have no more than two to three functions that are fixed, and therefore may be limited with which such remote controllers may be utilized, as well as the configuration of amplifier channels and input sources that may be controlled by such remote controllers. Alternatively, while digital remote controllers may be configured for multiple functions/modes, they are dependent upon embedded software and are not configurable to change default functions that are factory-set. Changes must be programmed via a remote computer system to overwrite default functions.

### SUMMARY

One embodiment of the present disclosure is a multifunction remote controller for an audio processor. The multifunction remote controller may include a function setting switch. At least one switch input signal corresponding to position settings of the function setting switch may be generated and passed to corresponding ones of at least one switch output terminal. The multifunction remote controller may also include a rotary encoder with at least one directional output terminal. A rotary input signal corresponding to a specific directional input applied to the rotary encoder may be generated from the at least one directional output terminal. There may also be an interconnect port in communication with the at least one switch output terminal and the at least one directional output terminal. The interconnect port may be receptive to a connector plug in communication with the audio processor.

Another embodiment of the present disclosure is an audio processor system. There may be a set of audio input ports connectable to a main audio source and receptive to an audio signal therefrom, along with a set of audio output ports connectable to one or more loudspeakers and associated with audio channels. The audio processor system may include a rotary encoder with a first directional output terminal and a second directional output terminal. A rotary input signal corresponding to directional input applied to the rotary encoder may be generated from the respective first and second directional output terminal. The audio processor system may also include one or more function setting switches. Switch input signals may be generated from corresponding ones of the one or more function setting switches by respective positions thereof and passed to switch output terminals. The audio processor system may also include a controller with inputs connected to the first and second directional output terminals of the rotary encoder, and to the switch output terminals of the function setting switches. Specific command outputs generated by the controller in response to the rotary input signal may be selected based upon the switch input signals.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a front perspective view of a multi-function remote controller in accordance with one embodiment of the present disclosure;

FIG. 2 is a rear plan view of the multi-function remote controller;

FIG. 3 illustrates an output terminal panel of a first embodiment of an audio processing module that cooperates with the multi-function remote controller;

FIG. 4 illustrates an output terminal panel of a second embodiment of the audio processing module that cooperates with the multi-function remote controller;

FIG. 5 is a block diagram of components of the multi-function remote controller;

FIG. 6A-6C are schematic diagrams showing the various interconnections of the integrated circuit components of the multi-function remote controller; and

FIGS. 7A-7D depicts various toggle switch settings and corresponding functions that are accessible via the multi-function remote controller.

Common reference numerals are used throughout the drawings and the detailed description to indicate the same elements.

### DETAILED DESCRIPTION

The detailed description set forth below in connection with the appended drawings is intended as a description of the presently preferred embodiments of the multifunction remote controller, and is not intended to represent the only form in which the presented embodiments may be developed or utilized. It is further understood that the use of relational terms such as first and second and the like are used solely to distinguish one from another entity without necessarily requiring or implying any actual such relationship or order between such entities.

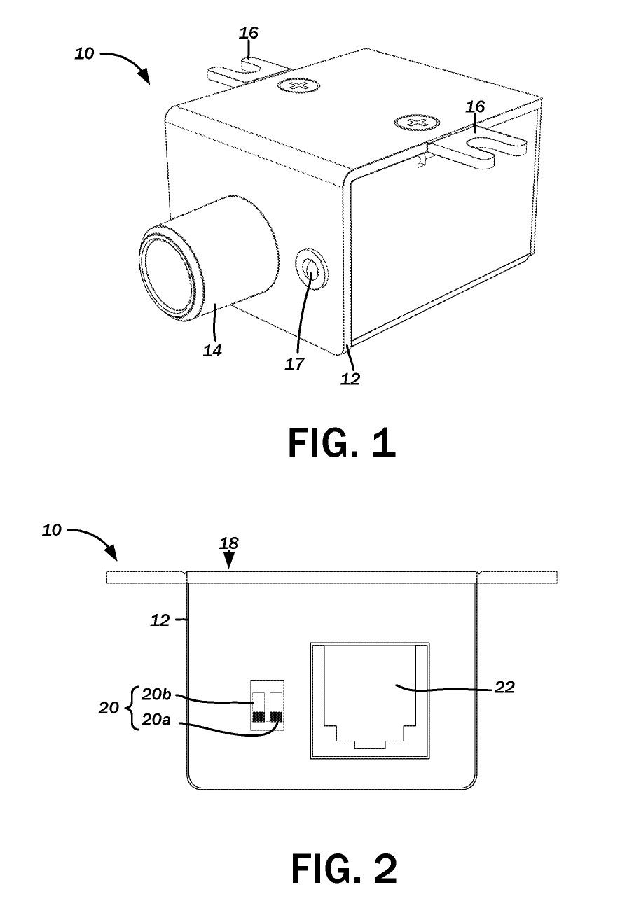

FIG. 1 depicts one embodiment of a multifunction remote controller 10 in accordance with the present disclosure generally comprised of an enclosure 12 with an externally accessible, rotating knob 14 extending from the enclosure 12. The knob 14 is understood to be coupled to a shaft of a rotary encoder, the additional details of which are described more fully below. The knob 14 may also be pressed and/or held pressed in order to activate additional functions, and thus the rotary encoder is understood to incorporate a pushbutton switch actuated by an axial movement of the shaft via the knob 14. The enclosure 12 may include a pair of tabs 16 via which the multifunction remote controller 10 is mounted to a structure, e.g., the interior structure of the vehicle in a car audio installation.

The multifunction remote controller 10 also includes an indicator lamp 17 that is mounted to the enclosure 12 for visibility while manipulating the knob 14. According to one embodiment, the indicator lamp 17 may be a multiple color light emitting diode capable of outputting a red light and a blue light, though other colors are also possible. Furthermore, with suitable output driver circuitry, the indicator lamp 17 may be flashed or continuously illuminated to provide indication of different operating states of the multifunction remote controller 10. Although the indicator lamp 17 is mounted to the enclosure 12 in a preferred embodiment, this is by way of example only and not of limitation. The indicator lamp 17 may be mounted externally, with suitable connections being made to the output driver circuit in the multifunction remote controller 10.

Turning to FIG. 2, the multifunction remote controller 10, and specifically a rear end 18 opposite the front face from which the knob 14 extends, includes a pair of slide switches 20 that are each characterized by an “on” position or an “off” position. More particularly, there is a first slide switch 20a and a second slide switch 20b that can be set to correspond to one of four input states. A first switch input state is with both the first slide switch 20a and the second slide switch 20b being in the “off” state, which may be represented in binary notation as “00.” A second switch input state is with the first slide switch 20a being in the “off” state and the second slide switch 20b being in the “on” state, which may be represented in binary notation as “10.” A third switch input state is with the first slide switch 20a being in the “on” state and the second slide switch 20b being in the “off” state, which may be represented in binary notation as “01.” Finally, a fourth switch input state is with the both the first slide switch 20a and the second slide switch 20b being in the “on” state, which may be represented in binary notation as “11.” These switch input states may be set to define the corresponding output signals that are generated in response to actuating the rotary encoder. Although the present disclosure refers to slide switches 20, other like switch configurations such as rotary-types in which the switch input states can be set, may be utilized without departing from the scope of the present disclosure.

In addition to the slide switches 20, the multifunction remote controller 10 may include an output connection port 22. The multifunction remote controller 10 includes various circuitry that generates output signals in response to the inputs provided via the rotary encoder and the slide switches 20. These output signals are transmitted to audio processing modules and/or audio amplifiers to set amplification levels, volume, etc., and such transmissions are understood to occur over interconnect cables that link the multifunction remote controller 10 to the audio amplifier or audio processing module. By way of example only and not of limitation, the output connection port 22 is a standard RJ-45 type socket/physical interface, to which a corresponding RJ-45 plug may be connected.

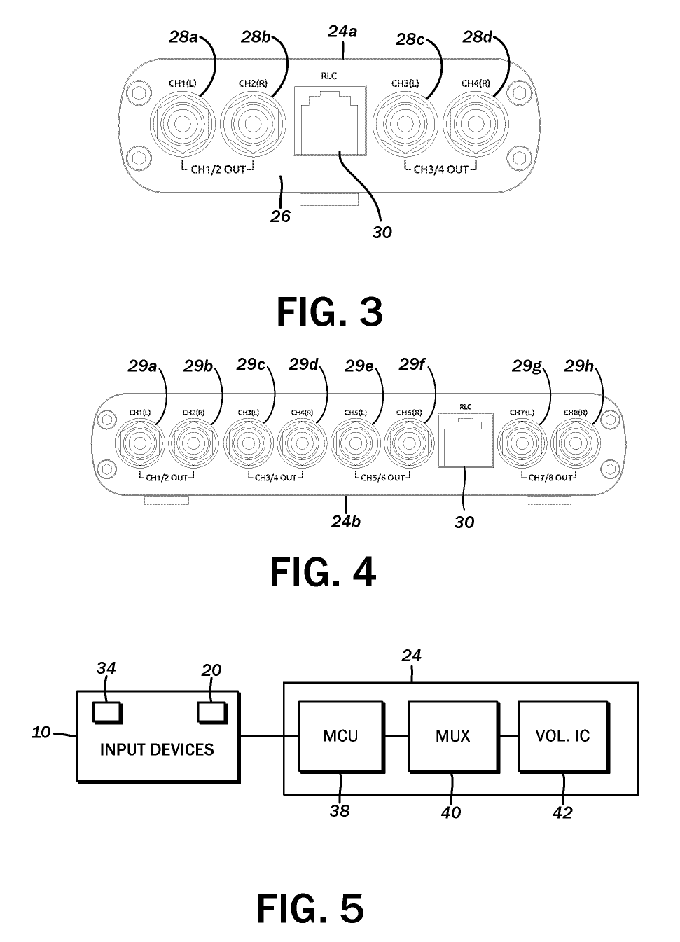

FIG. 3 illustrates a first embodiment of an audio processor 24a, specifically depicting an output terminal panel 26 thereof. The audio processor 24a has multiple output channels that are connected to different loudspeakers within the vehicle installation, and may thus have multiple terminals corresponding thereto. For example, the installation may include a pair of full-range loudspeakers, with one being designated for the left side and the other being designated for the right side. In such configuration, the left full-range loudspeaker may be driven by a first amplifier channel, corresponding to a first channel terminal 28a. The right full-range loudspeaker may be driven by a second amplifier channel, corresponding to a second channel terminal 28b. Furthermore, there may also be a single subwoofer that is driven by a pair of amplifier channels with outputs corresponding to a third channel terminal 28c and a fourth channel terminal 28d. The various embodiments of the multifunction remote controller 10 are contemplated to allow the adjustment of the signals output from these channel terminals 28 in different ways. To this end, the audio processor 24a includes an input connection port 30, which is likewise an RJ-45 socket that receives an RJ-45 plug that is part of a cable connecting to the counterpart plug for the output connection port 22 of the multifunction remote controller 10.

FIG. 4 illustrates a second embodiment of the audio processor 24b with additional audio channels and terminals 29 therefor. In this embodiment, there are eight total amplifier channels that may be organized into pairs of terminals that each correspond to a left or a right output. By way of example only a first channel terminal 29a and a second channel terminal 29b correspond, respectively, to a left amplifier channel output and a right channel amplifier output of a first amplifier output 31a. A third channel terminal 29c and a fourth channel 29d may correspond, respectively, to a left amplifier channel output and a right channel amplifier output of a second amplifier output 31b. A fifth channel terminal 29e and a sixth channel terminal 29f may correspond, respectively, to a left amplifier channel output and a right channel amplifier output of a third amplifier output 31c. A seventh channel terminal 29g and an eighth channel terminal 29h may correspond, respectively, to a left amplifier channel output and a right channel amplifier output of a third amplifier output 31d. The organization of these pairs of amplifier outputs and corresponding terminals are presented by way of example only and not of limitation.

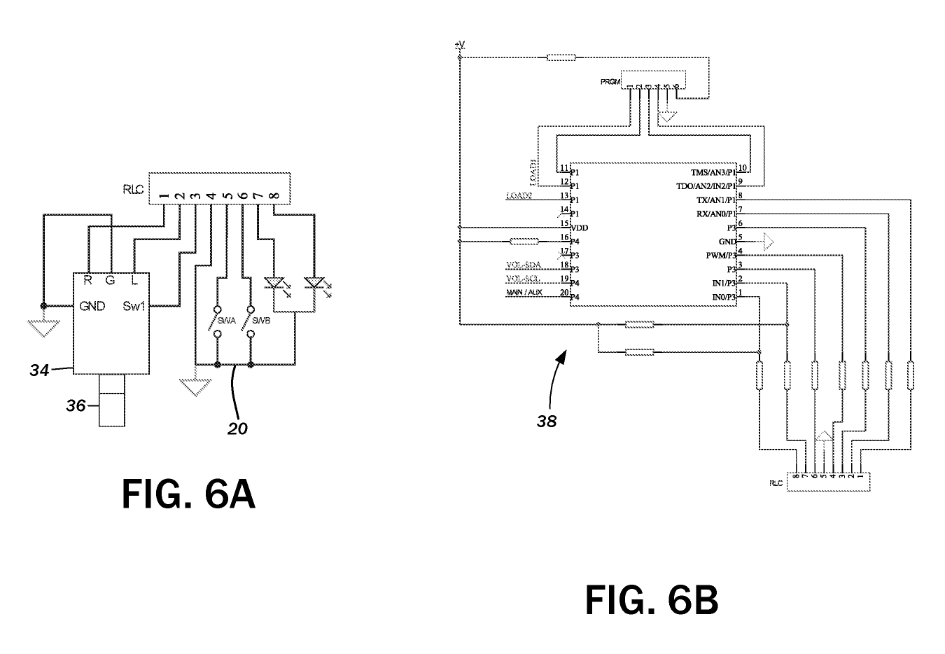

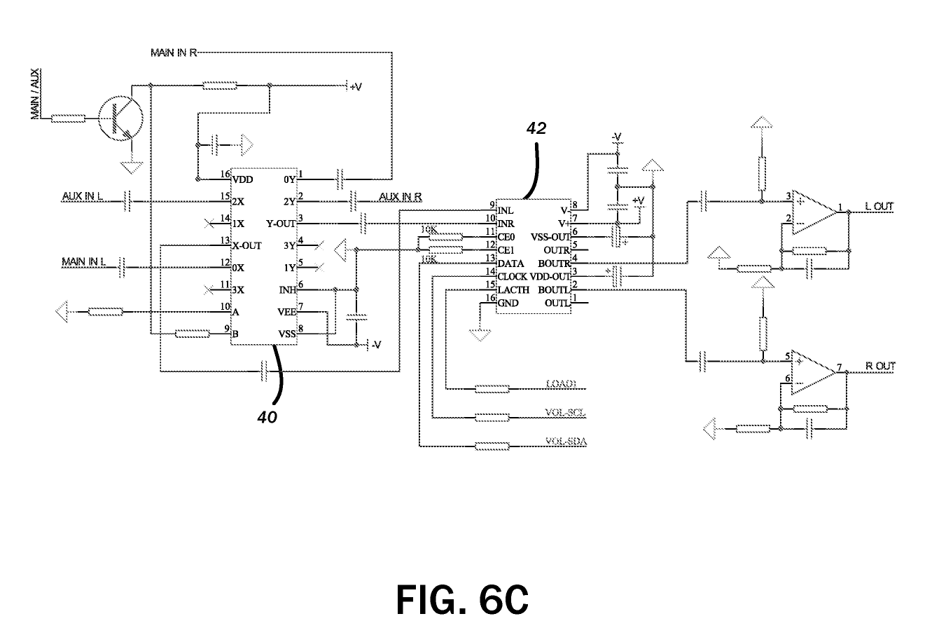

With reference to the block diagram of FIG. 5 the multifunction remote controller 10 is generally comprised of a rotary encoder 34 and the aforementioned switches 20, which may also be referred to in the aggregate as a function setting switch. One exemplary implementation of the circuitry of the rotary encoder 34 and the switches 20 is illustrated in further detail in FIG. 6A. The rotary encoder 34 includes a plurality of output terminals R, G, and L, and actuator shaft 36 as noted above. As will be understood by those having ordinary skill in the art, as the actuator shaft 36 is rotated to the right or to the left, a corresponding pulsed signal is generated by the rotary encoder 34. The on/off states of the switches 20 are also output as corresponding signals, which may be referred to as switch input signals.

These output signals are passed to a main control unit 38 that is understood to be part of the audio processor 24. The schematic diagram of FIG. 6B depicts one embodiment of the main control unit 38, which receives the aforementioned signals from the rotary encoder 34 and the switches 20 and performs various data processing operations thereon to generate responsive outputs. With additional reference to the schematic diagram of FIG. 6C, these outputs are connected to a multiplexer 40, as well as to a volume control integrated circuit 42. It is expressly contemplated that the multiplexer 40 receives a plurality of incoming audio signals from a head unit or other signal source, and after such signals are appropriately processed (e.g., applying a delay, amplification, etc.) combines, divides, and routes the signals to the appropriate channel terminals 28.

Various embodiments of the multifunction remote controller 10 contemplate the storage of the different modes of operation in the memory of the main control unit 38, so no additional programming is understood to be necessary. The inputs provided via the switches 20 are contemplated to trigger overrides of default functions of the rotary encoder 34 for different use cases. The user is not exposed to the complexity of the different modes, as they are set by the installer.

The multifunction remote controller 10 is understood to be utilized for controlling the volume of a main audio source and an auxiliary audio source, as separately delivered to a primary pair of loudspeakers and a subwoofer.

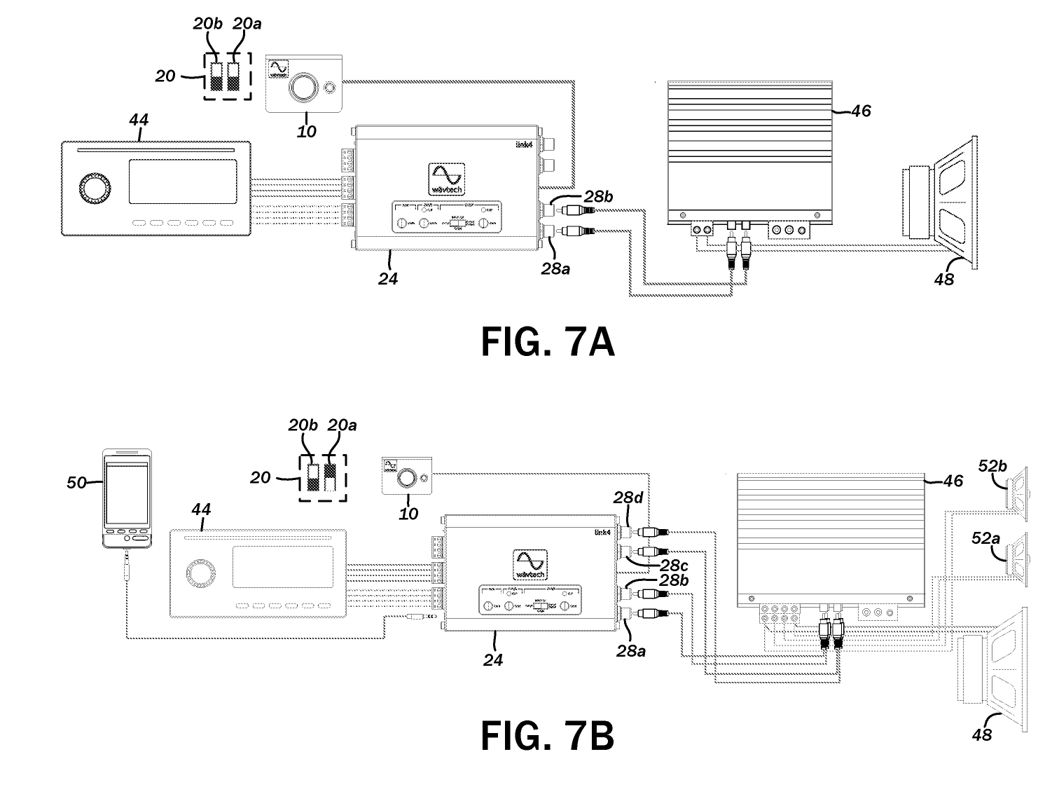

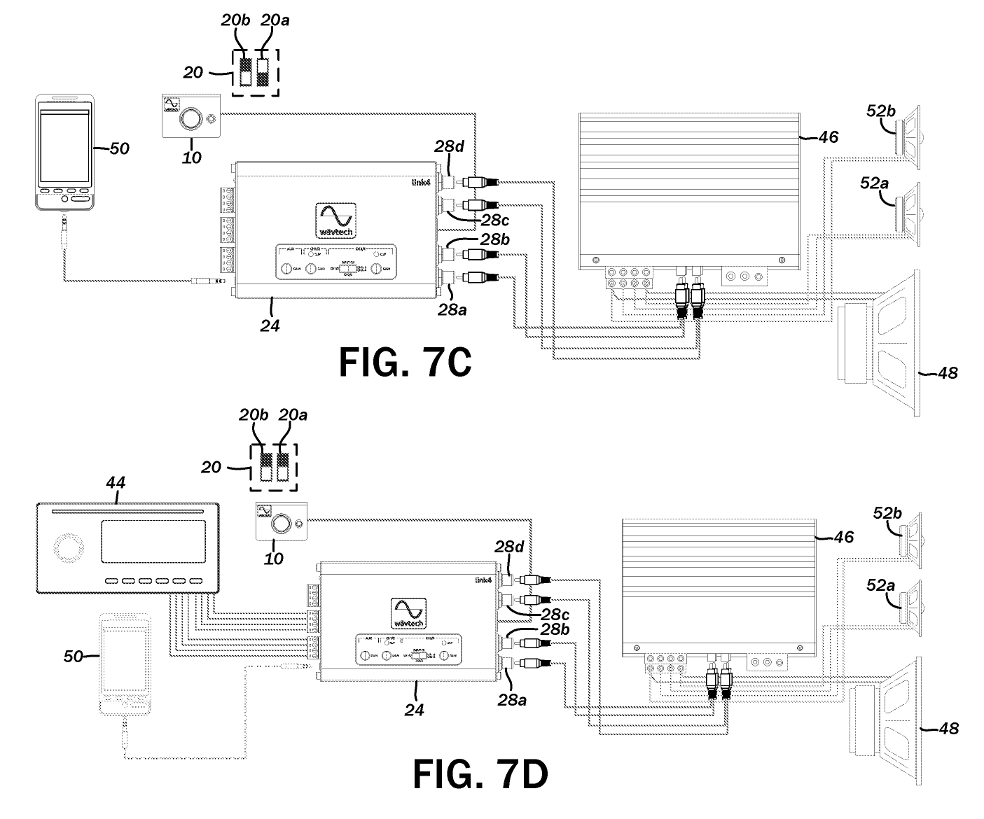

The block diagram of FIG. 7A illustrates a first configuration with a main audio source 44 connected to the audio processor 24, with the first and second channel terminals 28a, 28b being connected to an amplifier 46. A subwoofer 48 is connected to the amplifier 46. In this first configuration, because there is no auxiliary audio source, the pushbutton function of the multifunction remote controller 10 is disabled. By turning the rotary encoder 34 clockwise and counterclockwise, the volume level of the lower frequency components of the audio signal intended for the subwoofer 48 may be increased or decreased. Thus, the multifunction remote controller 10 has a single function in such configuration. While the rotary encoder 34 is so activated, or alternatively at all times, the indicator lamp 17 may be illuminated a first color (e.g., red) continuously. In order to set this function mode, the switches 20 may be set to the first switch input state, with both the first slide switch 20a and the second slide switch 20b being “off.”

The block diagram of FIG. 7B illustrates a second configuration with a main audio source 44 as well as an auxiliary audio source 50 connected to the audio processor 24. The first and second channel terminals 28a, 28b, as well as the third and fourth channel terminals 28c, 28d are connected to the amplifier 46. The subwoofer 48 is connected the amplifier 46, as are a pair of full range drivers 52a, 52b. The default function of the rotary encoder 34 may be either the subwoofer level control for main audio source 44, or the volume control for the auxiliary audio source 50. Toggling between these two functions may be possible by actuating the pushbutton switch of the rotary encoder 34 (e.g., pushing the knob 14 for a short duration). The volume of the main audio source 44 is understood to be directly controlled via a volume knob thereof.

When the multifunction remote controller 10 is configured to adjust the subwoofer level for the main audio source 44 as the first function, the indicator lamp 17 is continuously illuminated in the first color, e.g., red. Alternatively, when the multifunction remote controller 10 is configured to adjust the volume of the auxiliary audio source 50 according to a second function, then the indicator lamp 17 is continuously illuminated in a second color, e.g., blue. By keeping the knob 14 pushed in for a longer duration (for example, longer than 2 seconds), then the multifunction remote controller 10 may be configured to adjust only the subwoofer level for the auxiliary audio source 50 in a third function. In this function mode, the indicator lamp 17 may be flashed in the second color, e.g., blue. When a predetermined time duration such as five seconds elapses without any input from the rotary encoder 34, there may be a transition back the aforementioned second function, returning the indicator lamp 17 to the continuously illuminated second color.

The foregoing function mode may be set with switches 20 in the second switch input state, that is, the first slide switch 20a “on” and the second slide switch 20b “off.” Generally, the knob 14 is understood to control the subwoofer level, with the volume is the priority when the multifunction remote controller 10 is set for the auxiliary audio source 50. The subwoofer level for the auxiliary audio source 50 may also be controlled following entry into such mode via a long duration press of the knob 14.

The block diagram of FIG. 7C illustrates a third configuration with only the auxiliary audio source 50 connected to the audio processor 24. The first and second channel terminals 28a, 28b, as well as the third and fourth channel terminals 28c, 27d are connected to the amplifier 46. The subwoofer 48 is connected to the amplifier 46, as are the pair of full range drivers 52a, 52b. The pushbutton function of the multifunction remote controller is understood to toggle between the volume and the subwoofer level of the auxiliary audio source 50, and the pushbutton switch of the rotary encoder 34 may be pushed for an extended duration e.g., longer than two seconds, to so toggle between the functions. While in the first function, the indicator lamp 17 may be continuously illuminated the second color, e.g., blue, while in the second function, the indicator lamp 17 may be flashed the second color. When a predetermined time duration such as five seconds elapses without any input from the rotary encoder 34, there may be a transition back the aforementioned first function, returning the indicator lamp 17 to the continuously illuminated second color.

The foregoing function mode may be set with switches 20 in the third switch input state, that is, the first slide switch 20a “off” and the second slide switch 20b “on.” Generally, the auxiliary volume is the priority, while an independent subwoofer level is adjustable via a long push of the knob 14.

The block diagram of FIG. 7D illustrates a fourth configuration with a main audio source 44 as well as an auxiliary audio source 50 connected to the audio processor 24. The first and second channel terminals 28a, 28b, as well as the third and fourth channel terminals 28c, 28d are connected to the amplifier 46. The subwoofer 48 is connected to the amplifier 46, as are a pair of full range drivers 52a, 52b. In this function mode, it is possible to adjust the volume levels for both the main audio source 44 and the auxiliary audio source 50, as well as the subwoofer levels thereof. The multifunction remote controller 10 defaults to adjusting the volume of the audio source, whether that be the main audio source 44 or the auxiliary audio source 50. Short duration pushes of the knob 14, that is, actuation of the pushbutton connected to the rotary encoder 34 switches between the main audio source 44 and the auxiliary audio source 50.

While in the volume control mode for the main audio source 44, an extended duration push of the knob 14 actuates a subwoofer level adjustment mode for the main audio source 44. In such mode, the indicator lamp 17 may be flashed, whereas in the volume control mode, the indicator lamp 17 may be continuously illuminated. In either case, because the controls are in relation to the main audio source 44, the indicator lamp 17 outputs the first color, e.g., red. Where no inputs on the rotary encoder 34 are received for a predetermined duration, the multifunction remote controller 10 reverts to the volume control mode.

While in the volume control mode for the auxiliary audio source 50, an extended duration push of the knob 14 actuates a subwoofer level adjustment mode for the auxiliary audio source 50. The indicator lamp 17 is likewise flashed while in the mode to adjust the subwoofer level. The indicator lamp 17 is continuously illuminated while in the mode to adjust the volume of the auxiliary audio source 50. In either case, because the controls are in relation to the auxiliary audio source 50, the indicator lamp 17 outputs the second color, e.g., blue.

The foregoing function mode may be set with switches 20 in the fourth switch input state, that is, the first slide switch 20a “on” and the second slide switch 20b “on.” This configuration may be useful where the volume control on the main audio source 44 is not used, though both the main audio source 44 and the auxiliary audio source 50 are present. A master volume control for factory/OEM systems that have vehicle speed-dependent volume and/or equalizer is contemplated with this function mode of the multifunction remote controller 10. Volume control in systems that utilize a fixed signal is possible with this configuration as well.

The particulars shown herein are by way of example and for purposes of illustrative discussion of the embodiments of the disclosure only and are presented in the cause of providing what is believed to be the most useful and readily understood description of the principles and conceptual aspects. In this regard, no attempt is made to show details with more particularity than is necessary for the fundamental understanding of the present disclosure, the description taken with the drawings making apparent to those skilled in the art how the several forms of the present disclosure may be embodied in practice.

What is claimed is:

1. A multifunction remote controller for an audio processor, comprising:
a function setting switch, at least one switch input signal corresponding to position settings thereof being generated and passed to corresponding ones of at least one switch output terminal;
a rotary encoder having at least one directional output terminal, a rotary input signal corresponding to a specific directional input applied to the rotary encoder being generated from the at least one directional output terminal; and
an interconnect port in communication with the at least one switch output terminal and the at least one directional output terminal, the interconnect port being receptive to a connector plug in communication with the audio processor.

2. The remote controller of claim 1, wherein the function setting switch includes a first switch element and a second switch element.

3. The remote controller of claim 2, wherein each of the first and second switch elements is a two-position sliding switch, with a first position setting corresponding to an on state, and a second position setting corresponding to an off state.

4. The remote controller of claim 3, wherein the switch input signals are defined according to a combination of position settings of the first and second switch elements of the function setting switch.

5. The remote controller of claim 1, wherein the output terminals of the rotary encoder include a left rotation output terminal and a right rotation output terminal.

6. The remote controller of claim 5, wherein a right rotary input signal is generated in response to a right directional input applied to the rotary encoder, the right rotary input signal being output from the right rotation output terminal.

7. The remote controller of claim 5, wherein a left rotary input signal is generated in response to a left directional input applied to the rotary encoder, the left rotary input signal being output from the left rotation output terminal.

8. The remote controller of claim 1, wherein the generated signal is a pulsed signal that has a duty cycle proportional to a rotation rate of the direction input applied to the rotary encoder.

9. The remote controller of claim 1, further comprising:
a push button coupled to the rotary encoder;
wherein an axial push input applied to the rotary encoder actuates the push button.

10. The remote controller of claim 9, wherein the output terminals of the rotary encoder include an axial push output terminal.

11. The remote controller of claim 10, wherein an axial push input signal corresponding to the axial push input applied to the rotary encoder.

12. An audio processor system, comprising:
a set of audio input ports connectable to a main audio source and receptive to an audio signal therefrom;
a set of audio output ports;
a rotary encoder with a first directional output terminal and a second directional output terminal, a rotary input signal corresponding to directional input applied to the rotary encoder being generated from the respective first and second directional output terminal;
one or more function setting switches, switch input signals being generated from corresponding ones of the one or more function setting switches by respective positions thereof and passed to switch output terminals; and
a controller with inputs connected to the first and second directional output terminals of the rotary encoder, and to the switch output terminals of the function setting switches, specific command outputs generated by the controller in response to the rotary input signal being selected based upon the switch input signals.

13. The audio processor system of claim 12, further comprising:
a multiplexer commanded by the controller and connected to the set of audio input ports and to the set of audio output ports, the multiplexer selectively connecting the audio input port to the audio output ports.

14. The audio processor system of claim 13, further comprising:
a volume control circuit commanded by the controller and connected to the multiplexer, a volume level of a selected audio channels associated with the set of audio output ports being adjustable in response to the command outputs from the controller.

15. The audio processor system of claim 12, wherein a first set of command outputs generated by the controller is associated with a first control function, and a second set of command outputs generated by the controller is associated with a second control function.

16. The audio processor system of claim 15, further comprising:
a push button coupled to the rotary encoder, an axial push input applied to the rotary encoder actuating the push button with a push button input signal being generated in response, the push button input signal toggling the first control function to the second control function.

17. The audio processor system of claim 16, wherein the first control function is toggled to the second control function in response to the push button input signal continuing for a predetermined threshold duration.

18. The audio processor system of claim 12, wherein the function setting switch includes a first switch element and a second switch element.

19. The audio processor system of claim 18, wherein each of the first and second switch elements is a two-position sliding switch, with a first position setting corresponding to an on state, and a second position setting corresponding to an off state.

20. The audio processor system of claim 19, wherein the switch input signals are defined according to a combination of position settings of the first and second switch elements of the function setting switch.
